(19) United States
(12) Patent Application Publication
(10) Pub. No.: US 2011/0284323 A1
(43) Pub. Date: Nov. 24, 2011

(54) ROPE HANDLING DEVICE WITH SECONDARY LOCKING FEATURE

(76) Inventor: William H. AYRE, Seattle, WA (US)

(21) Appl. No.: 13/196,431

(22) Filed: Aug. 2, 2011

Related U.S. Application Data
(63) Continuation-in-part of application No. PCT/US2010/022666, filed on Jan. 29, 2010.
(60) Provisional application No. 61/206,675, filed on Feb. 2, 2009.

(51) Int. Cl. A62B 1/06; A63B 29/02; A62B 1/14; A62B 1/16

(52) U.S. Cl. 182/5

(57) ABSTRACT

Rope handling devices that can be used for belaying, descending and rappelling are disclosed and provide a secure lock off without requiring the use of specialized knots. A secondary rope lock off feature, which provides for locking the ends of two ropes using a single snap link is also disclosed. In general, rope handling devices of the present invention have a body with at least one closed-ended slot and at least one open-ended slot. A loop of rope may be passed through the closed-ended slot(s) from an upper area and retained within the closed-ended slot by attachment of a first snap link to the loop of rope from below the lower area of the slot. A brake strand of rope may be positioned within the open-ended slot to aid in arresting a fall or lowering a climber. Further, the brake strand may be entrapped within the open-ended slot by attaching a second snap link through at least one aperture proximal to the open-ended slot.

### REFERENCE TO RELATED APPLICATION

This patent application is a continuation-in-part application of PCT International Application No. PCT/US2010/022666 filed Jan. 29, 2010, which claims priority to U.S. provisional patent application No. 61/206,675 filed Feb. 2, 2009.

### FIELD OF THE INVENTION

This invention is related to rope handling devices for controlling the movement of rope with respect to various structural elements of the device, allowing both free movement of the rope through the device as well as providing braking and securing of rope using the device, all under the control of the operator. More specifically, this invention is related to rope handling devices such as belaying, descending and rappelling devices for use by climbers, climbing guides, and rope rescue personnel, and is related to devices that provide for: belay of a leader; belay of one or two seconds; rappel on single or double ropes; and belay and lowering of a climber on a top rope.

### BACKGROUND OF THE INVENTION

It is to be understood that in the following discussions, the use of the terms “belay device” and “rappel device” may refer to belay-rappel devices that can provide both functions.

Current belay devices fall roughly into three main categories:
‘figure eight’ type belay devices;
slotted belay devices including belay plates, tubular (including semi-tubular) belay devices, and captured snap link belay devices that lock the rope by sliding the snap link into a jamming position against the rope if the climber falls; and
mechanical belay devices having components that move with respect to one another that ‘automatically’ lock the rope in the event of a climber fall; typically involving a cam action or friction jam of the rope between two parts of the belay device attached to each other by a mechanical pivot point and often called “assisted locking” belay devices.

Tubular belay devices in the second category are, at this time, the most popular belay devices used for climbing outdoors on rock. Tubular belay devices are known for better rope control than figure eight belay devices for belay and rappel, and are less prone to twisting of the rope, which figure eight belay devices are prone to do. Tubular belay devices generally exhibit good rope feed characteristics. Popular tubular belay devices typically have two slots and accommodate common double strand rappel. Some tubular belay devices have “V” shaped channels through/over which the brake end of the rope can slide, thus affording increased friction and greater operator control during braking, lowering, and rappelling, which is desirable with modern skinny ropes.

Several newer tubular belay-rappel devices allow for a type of automatic locking when the ‘second’ or following climber is belayed off an anchor by the lead climber. Most of these belay devices have a single special opening to attach the belay device to the anchor, as has been available with some older belay plate designs. Some of these belay devices have long slots that allow a snap link to be mounted through the slot at the same time as the rope. This type of automatic locking feature with belay off the anchor is termed “autoblock” and is desirable for safety and rope management, and it allows climbing guides to safely belay two clients at the same time. However, many of these newer belay devices have reduced slot sizes as skinny ropes have become more popular, thereby rendering them more difficult to use with the older ‘standard’ rope sizes.

Most mechanical automatic/assisted locking belay devices, as well as captured snap link locking belay devices, are limited to accommodating a single rope, necessitating a special single strand rappel, or necessitating that the climber carry a separate rappel device on his or her harness, or limiting the climber's activities to top rope climbing where the climber need not rappel. Mechanical assisted locking belay devices tend to be sensitive to rope size, and the recommended range of rope diameters for use with each such device may not accommodate both modern skinny ropes and larger old standard ropes, again leading to limitations in their use or requiring the climber to carry additional equipment. Moreover, rope feed characteristics of assisted locking devices are often problematic, especially during passing rope to a lead climber, because a sharp pull on the climber's end of the rope is what assists locking.

All climbing techniques, regardless of the device(s) used, require the belayer to be attentive and to maintain a hand on the brake strand of the rope, even while belaying with mechanical automatic/assisted locking belay devices, to insure that they will lock properly. However, once most mechanical automatic/assisted (or captured snap link) locking belay devices are locked and under rope tension, the belayer may remove the brake hand and the locking belay device will remain securely locked. Easy and secure locking of the climber's rope under tension, without having to tie special knots or attach accessory devices to the rope, is a desirable feature. These secure locking belay devices allow the belayer to easily and safely rest his or her hands or perform some other function, such as take a photograph, while a climber is hanging on the rope and the belay device is in the locked off condition. Also, a climber on rappel using one of these belay devices in the locked off condition can easily hang on the rope and use both hands to retrieve gear from the rock or take a picture.

Using standard (not assisted locking) belay devices, the belayer must maintain a constant grip and force on the brake end of the rope to generate and hold a “lock off” condition on the rope. With these belay devices, the belayer (or climber on rappel) can securely “lock off” the rope only by tying off the brake end of the rope or by attaching a rope locking device to the brake end. The special knots required for securely tying off the rope can result in undesirable rope slippage during tying and untying, and many climbers are unaware of the correct knots and methods to tie them. Climbers frequently “tie off” the brake end of the rope with a few quick passes of the brake strand(s) of the rope around a leg while on rappel, and occasionally a belayer will do this when a climber is resting on the rope. Wrapping the brake strand(s) around the leg to “tie off” the belay or rappel is rapid and easy to perform and undo, however, it is an inherently unsafe practice.

### SUMMARY OF THE INVENTION

Rope handling devices of the present invention generally comprise a body having at least one closed-ended slot and at least one open-ended slot. The closed-ended slot is open to both an upper area and a lower area, such that a loop of rope may be passed through the slot from the upper area to extend from the lower area, and the loop of rope may be retained within the slot by attachment of a first locking member such as a snap link through the loop of rope from below the lower area of the slot. The two strands of the loop of rope so retained in the closed-ended slot pass out the upper area of the closed-ended slot and, for belay, one strand is attached to a climber and the other, the brake strand, may be positioned within the open-ended slot to aid in arresting a fall or lowering the climber. Further, the brake strand may be entrapped within the open-ended slot by attaching a second locking member such as a snap link through at least one aperture positioned proximal to the open-ended slot. For a loop of rope retained in the closed-ended slot as described above, entrapment of the brake strand of the rope within the open-ended slot securely locks off the rope, effectively braking and stopping motion of the rope through the rope handling device.

One objective of the rope handling device of the present invention is to combine an effective rope locking feature and function with desirable features and functions of the various belay devices described above, thus providing a rope handling device that can be used for both belay and rappel. The rope handling device of the present invention preferably provides a plurality of the following features and functions:
easy, convenient and secure locking of movement of rope in the rope handling device using only a second snap link, which then allows both hands to be free once the rope is locked while belaying or on rappel;
smooth rope feed characteristics using a broad range of rope sizes;
good control of braking on belay using a broad range of rope sizes (even for belayers who are of slight build and who are belaying larger, heavier climbers);
good control of lowering on rappel using a broad range of rope sizes; and
autoblock locking of a second, and independent locking for two seconds, when belaying off an anchor such that in the event of a climber fall, or if the following climber needs to hang and rest on the rope, tension of the climber on the rope halts further rope slippage through the rope handling device (while, if two climbers are being belayed, allowing the other climber to continue).

The inventive rope handling device allows safe, easy and secure hands free resting on rappel without the use of additional rope locking apparatus or special knots. It also allows a belayer to remove his or her brake hand safely and simply while a lead climber is hanging on the rope by securely locking the rope using only an additional snap link. The inventive rope handling device also allows the belayer to easily initiate escape from the belay in the event rescue procedures are necessary. The inventive rope handling device accommodates a broad range of rope sizes and allows good control of braking, lowering, and locking off with a broad range of rope sizes. The inventive rope handling device allows belay off the anchor for one or two follows, with autoblock locking of the rope independently with two follows, as is desired by climbing guides. In addition, the inventive rope handling device allows the climbing rope (for rappel or belay applications) to be locked in the rope handling device even when there is no tension on the rope, allowing safe movement of a rappelling climber prior to rappel and safe movement of the lead climber prior to belay while high on a multi-pitch route.

### BRIEF DESCRIPTION OF THE DRAWINGS

Descriptions of specific and detailed embodiments of the invention, which are provided by way of example only, reference the accompanying Figs., wherein like numerals designate corresponding parts in the several drawings, and in which:

FIG. 1A Presents a perspective view of a first embodiment of rope handing device 100 of the present invention.

FIG. 1B Presents a top view of the device shown in FIG. 1A.

FIG. 1C Presents a cut-away side view of the device shown in FIGS. 1A and 1B with a rope loop and a snap link.

FIG. 2A Presents a perspective view of the device embodiment illustrated in FIGS. 1A-1C, configured for belay of leader with single rope.

FIG. 2B Illustrates a perspective view of the device embodiment illustrated in FIGS. 1A-1C, with the secondary lock off feature engaged.

FIG. 3A Presents a perspective view of the device embodiment illustrated in FIGS. 1A-1C, configured with two ropes for belay of a leader with double ropes.

FIG. 3B Illustrates a perspective view of the device embodiment illustrated in FIGS. 1A-1C, with the secondary lock off feature engaged.

FIG. 4 Presents a perspective view of a rope handling device of the present invention comprising a specialized brake channel.

FIG. 5A Presents a perspective view of another embodiment of a rope handling device 101 of the present invention.

FIG. 5B Presents a perspective view of the device embodiment illustrated in FIG. 5A with the addition of a specialized brake channel.

FIG. 6 Presents a perspective view of a rope handling device of the present invention in use for belay of a second off anchor with single rope.

FIG. 7 Presents a perspective view of another embodiment of a rope handling device of the present invention having a single front aperture in a center extension.

FIG. 8 Presents a perspective view of a representative prior art symmetrical slotted belay device configured for belay of leader with single rope.

FIG. 9 Presents a perspective view of an alternative rope handling device of the present invention having open-ended slots oriented in a different orientation.

FIG. 10 Presents a perspective view of another embodiment of a rope handling device of the present invention illustrating an alternative construction employing a plurality of components mounted and fixed to one another.

FIG. 11A Presents a side perspective view of another embodiment of a rope handling device of the present invention illustrating a construction in which the sides and extensions comprise a contiguous component attached to a center component.

FIG. 11B Presents a front perspective view of the embodiment of FIG. 11A.

FIG. 11C Presents a rear perspective view of the embodiment of FIGS. 11A and 11B.

A listing of the reference numerals used in the drawings is provided following the detailed description.

### DETAILED DESCRIPTION

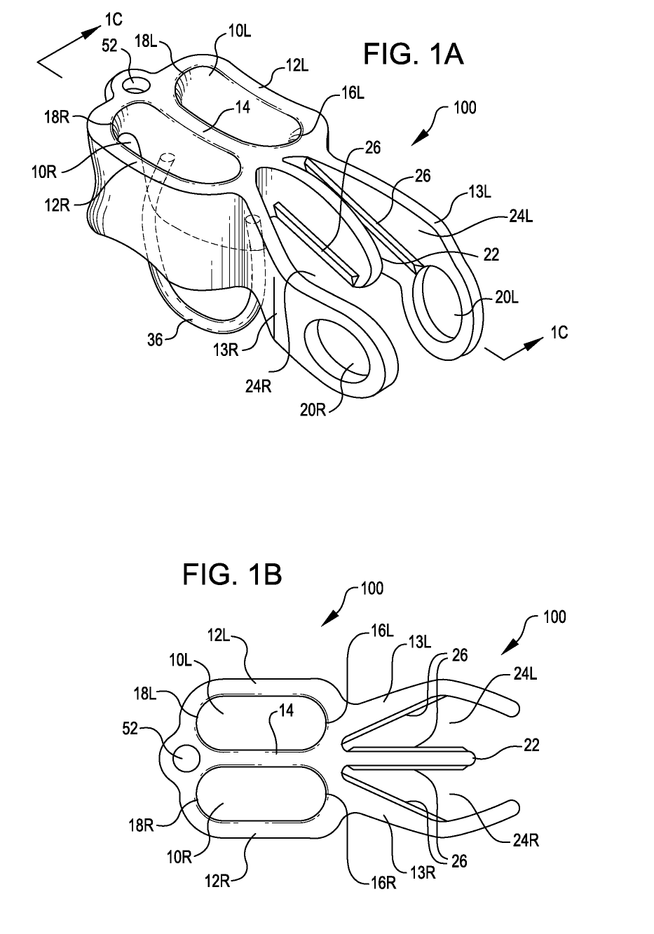

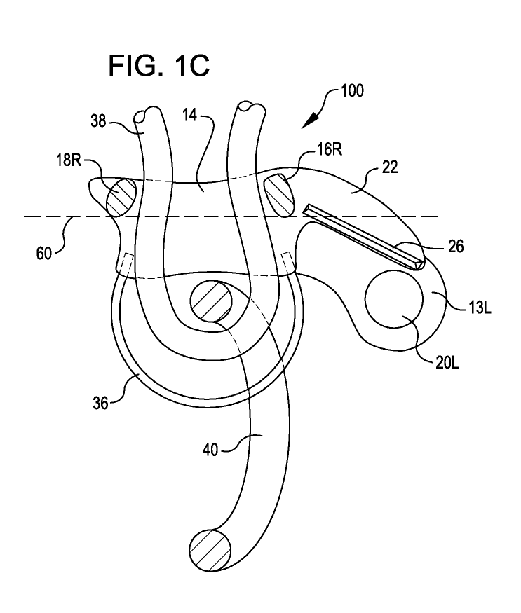

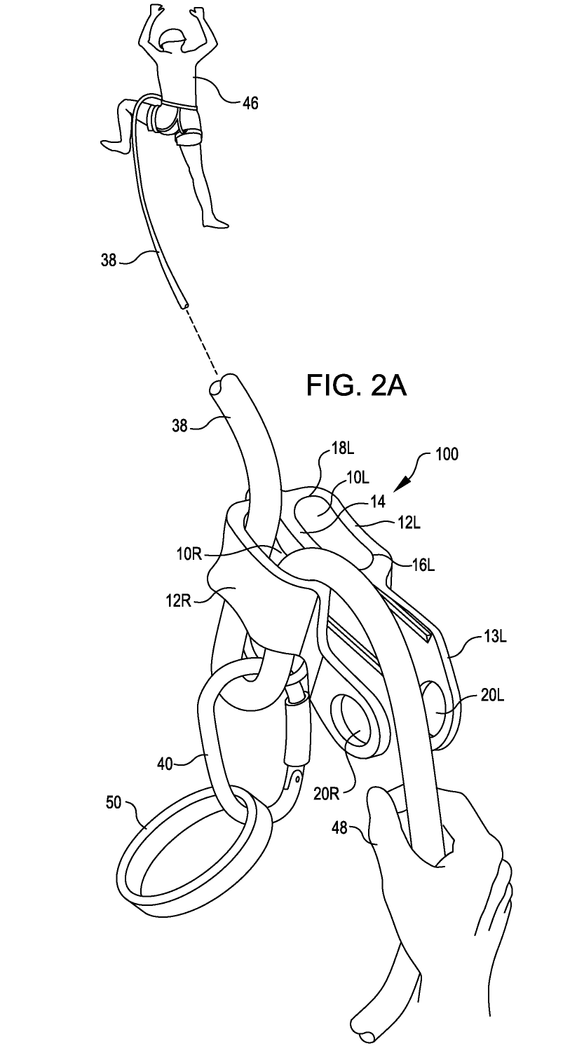

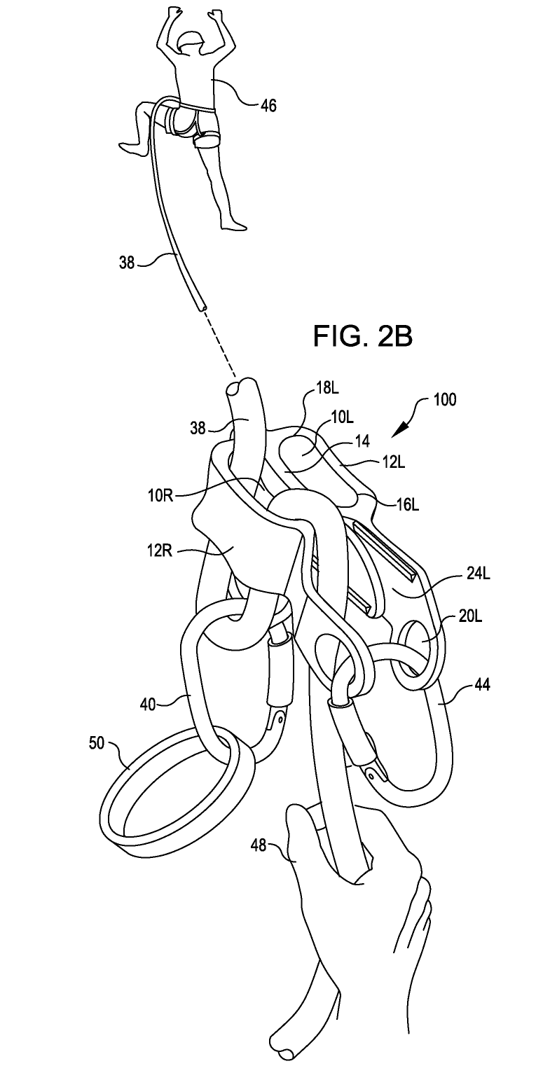

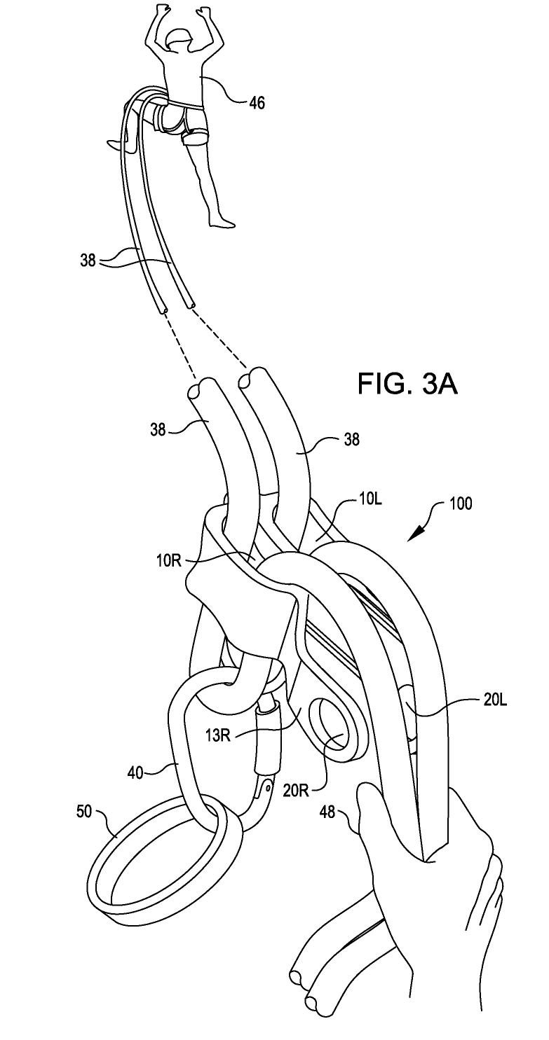

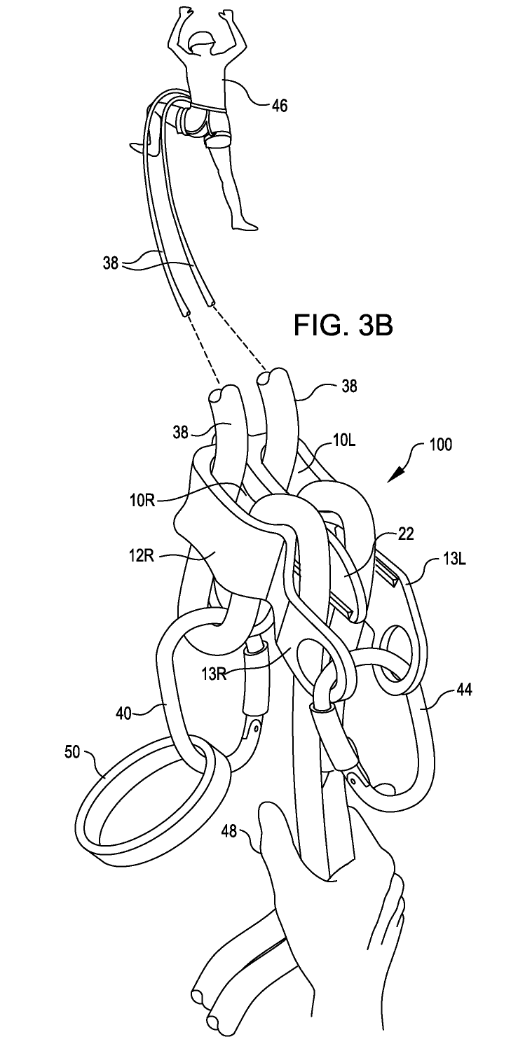

Referring to FIGS. 1A and 1B, rope handling device 100 comprises left and right slots 10L and 10R positioned between and left and right sides 12L and 12R, and separated by center divider 14. Divider 14 forms the inner surfaces of slots 10L and 10R, and sides 12L and 12R form the outer surfaces of slots 10L and 10R. Sides 12L and 12R connect with center divider 14 at a forward end of slots 10L and 10R to form left and right front slot-ends 16L and 16R. Sides 12L and 12R connect with center divider 14 at a rearward end of slots 10L and 10R to form left and right rear slot-ends 18L and 18R. Slots 10L and 10R are thereby closed-ended and have a substantially contiguous peripheral surface. Slots 10L and 10R as shown have a generally similar shape and size but may be of differing shapes and sizes, for example, to better accommodate a different size of rope in each slot. A loop of climbing rope 38 that is passed through slot 10L or 10R from above to form a loop extending below the slot may be retained in slot 10L or 10R by attaching a snap link 40 below slot 10L or 10R to the loop, as shown in FIGS. 2A and 3A, as long as the two strands of the loop formed by rope 38 are long enough to project from the top of slot 10L or 10R. Such a configuration, providing that a loop of rope 38 passing through slot 10L or 10R may be securely retained in the slot by attachment of snap link 40, which may be further attached to a harness loop 50, is used in climbing to belay and lower a climber 46.

In this description, the orientation of rope handling device 100 will be described with reference to the position of slots 10L and 10R having upper and lower openings and being situated next to each other in a horizontal, side by side orientation. In this orientation, center divider 14 has a front to rear longitudinal orientation with a top to bottom height and a generally narrow width separating slots 10L and 10R. The width of center divider 14 is generally less than its height.

Side extensions 13L and 13R extend forward from sides 12L and 12R and may be formed separately from or as extensions of sides 12L and 12R. Side extensions 13L and 13R further comprise apertures 20L and 20R positioned generally distally from slots 10L and 10R. Center extension 22 extends forward from divider 14 and may be formed separately from or as an extension of divider 14, and is situated between side extensions 13L and 13R. Center extension 22, in conjunction with side extensions 13L and 13R, form left and right open-ended slots 24L and 24R (See, e.g., FIG. 1B, top view) extending forward of left and right front slot-ends 16L and 16R. Side extensions 13L and 13R form the lateral sides of open-ended slots 24L and 24R, and center extension 22 forms the medial sides of open-ended slots 24L and 24R with respect to orientation of rope handling device 100 as defined above. Open-ended slots 24L and 24R taper from a narrow width at their region nearest front slot-ends 16L and 16R to a wider width near apertures 20L and 20R. Apertures 20L and 20R are sized and configured to accommodate passage and attachment of a second snap link 44 through both apertures simultaneously, as shown in FIGS. 2B and 3B, such that open-ended slots 24L and 24R are effectively closable upon positioning of the snap link. The brake strand of climbing rope 38 may be placed in open-ended slot 24L or 24R through the open end and entrapped by the attachment of second snap link 44 through both apertures 20L and 20R, as described more fully below.

Rope handling device 100 further comprises a retainer loop 36, as shown in FIGS. 1A and 1C. Loop 36 extends in an arced fashion below the body of the device and connects at its ends to center divider 14 proximal to front slot-ends 16L and 16R at its forward end, and proximal to rear slot-ends 18L and 18R at its rearward end. Loop 36 provides an opening through which rope handling device 100 may be attached by snap link 40 to a harness loop. Loop 36 may be constructed from a material that's substantially flexible or semi-rigid or rigid. Additionally, a vertical opening 52 may be centrally situated at rear aspect of the body of the device, proximal to center divider 14 and rear slot-ends 18L and 18R, to accommodate attachment of an accessory such as an accessory climbing cord to rope handling device 100.

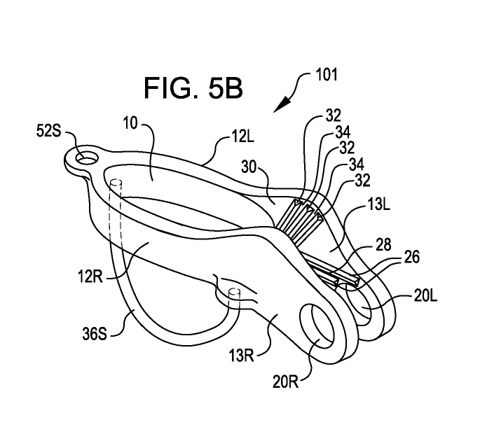

An alternative embodiment of rope handling device 101, shown in FIGS. 5A and 5B, comprises a single slot 10 between left and right sides 12L and 12R. The description and orientation of components of rope handling device 101 shall be understood to correspond to the description and orientation of components of rope handling device 100 as described above. Left and right sides 12L and 12R meet at the forward end of slot 10 to form front slot-end 16, and at the rearward end of slot 10 to form rear slot-end 18. As with rope handling device 100, slot 10 is closed-ended and a loop of climbing rope 38 passed through slot 10 from above may be retained in slot 10 by attaching a snap link 40 to the loop of climbing rope 38 received through the slot 10 from below the slot. Side extensions 13L and 13R extend forward beyond front slot-end 16 and may be formed as extensions of sides 12L and 12R. Side extensions 13L and 13R incorporate left and right apertures 20L and 20R provided distally of slot 10. Extensions 13L and 13R form an open-ended slot 24 that tapers from a narrow end nearest front slot-end 16, to a wider end near apertures 20L and 20R. A strand of rope 38 may be retained in slot 10 by placing the rope through open-ended slot 24 and entrapping the rope in the open-ended slot by attaching a snap link 44 through apertures 20L and 20R.

Rope handling device 101 further comprises a retainer loop 36S. Loop 36S extends in an arced fashion below slot 10. In one embodiment, loop 36S extends generally angularly below slot 10, connecting at its forward end to right side 12R proximal to front slot-end 16, and at its rearward end to left side 12L proximal to rear slot-end 18. Loop 36S provides an opening through which rope handling device 101 may be attached by a snap link 40 to a harness loop, not shown. Additionally, a vertical opening 52S may be situated at rear aspect of side 12R proximal to rear slot-end 18 to accommodate attachment of an accessory climbing cord to rope handling device 101.

Rope handling devices 100 and 101 may be constructed from rigid materials having generally high tensile strength, such as metallic materials. Rope handling devices may be constructed as unitary, single piece device bodies using manufacturing techniques that are well known in the art, including machining, forging and metal molding processes to form a solid bodied rope handling device. The retainer loops 36 and 36S may be formed separately, for example, and constructed from materials such as plastic coated cable. Retainer loops may be mounted and fastened at their ends within openings in the solid bodies of rope handling devices 100 and 101 using swaging and other techniques that are also well understood to those familiar with the art.

### Further Detailed Descriptions

For ease of reading and comprehension, the designations of “right” and “left” or “R” and “L” may be omitted in the following descriptions. It will be readily understood, in context, that with the exception of applications requiring or involving two ropes retained in the rope handling device, the following descriptions are applicable to both rope handling devices 100 and 101. Where the terminology “about” is used with respect to dimensions and other quantitative features, it is understood to encompass variations of up to 15% from the stated quantitative dimension or feature.

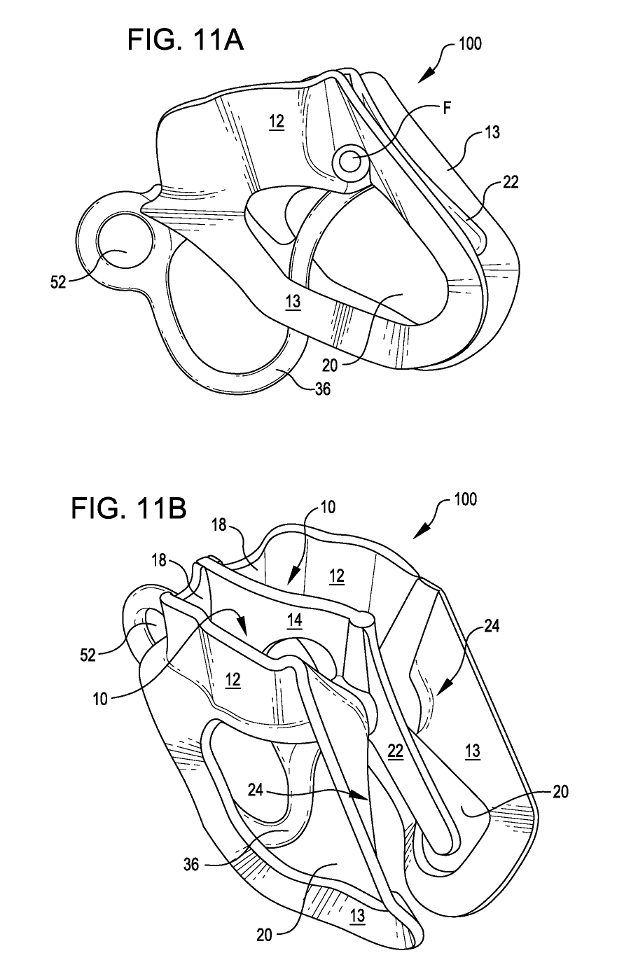

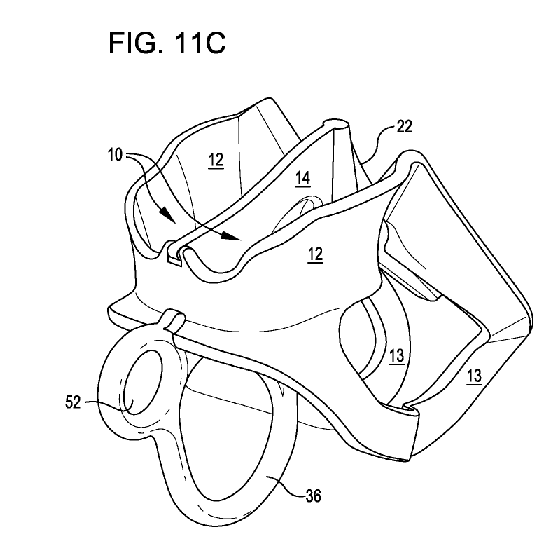

In one specific embodiment, slots 10 (including 10, 10L and 10R, as indicated in the paragraph above) in rope handling devices 100 and 101 have a width of about 15 mm and an overall length of about 35 mm, terminating at rounded front and rear slot-ends 16 and 18 seen best in FIG. 1B, top view. The surfaces of slot-ends 16 and 18 that face each other, their inner surfaces, angle away from each other from top to bottom with their lower aspects further apart than their upper aspects, as seen in FIG. 1C. These slot dimensions smoothly accommodate climbing ropes having diameters of 10 mm or 11 mm. In another embodiment of rope handling device 100 shown in FIGS. 11A-11C, slots 10 have a width that tapers from narrower in the rear (approximately 13 mm wide) to wider toward the front (approximately 16 mm wide). This varying width of the slots 10 in this embodiment of device 100 better accommodates belay functions and provides high performance using a wide range of rope sizes and types, ranging from approximately 9 mm to 10.5 mm in diameter. The angles of the lower inner aspect of slot-ends 16 and 18 allow smooth motion of a loop of climbing rope 38 retained through slot 10 by snap link 40, as shown in FIGS. 1C, 2A and 3A.

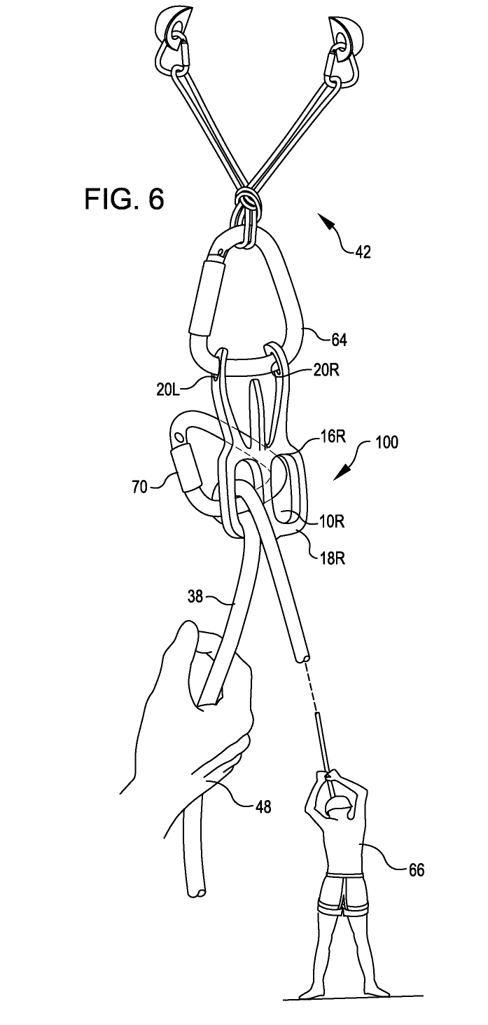

At the mid-region of slots 10 of rope handling device 100, the lower extent of center divider 14 and sides 12 may extend about 15 mm below a longitudinal mid-slot line 60 connecting the lower extent of front and rear slot-ends 16 and 18, as shown in FIG. 1C. The lower surfaces of center divider 14 and sides 12 form the limit of upward position for snap link 40 (or 70, FIG. 6) when retaining climbing rope 38 within slot 10. This upper limit for snap link 40 (or 70) functions to regulate the friction of rope 38 between snap link 40 (or 70) and front and rear slot-ends 16 and 18 by not allowing the rope to be pinched between front or rear slot ends (16 and 18) and snap link 44 (or 70). The above dimensions and function also apply to rope handling device 101, having a single slot and no center divider.

In a further specific embodiment of rope handling device 100, open-ended slots 24 may extend forward about 35 mm from the forward surface of front slot-ends 16, and at an angle of about 30 degrees down from horizontal, to top of apertures 20, shown in FIG. 1C. In the top view, open-ended slots 24 taper from a narrow, rounded width of about 3 mm nearest front slot-ends 16 to a 12 mm width at mid apertures 20, as shown in FIG. 1B. Apertures 20 are generally circular and have a diameter of about 16 mm, and they are positioned generally below the forward ends of open-ended slots 24. Apertures 20 are sized and configured for passage of a snap link 44, as shown in FIGS. 2B & 3B, or 64, as shown in FIG. 6, attached through both apertures 20L and 20R simultaneously.

The outer surfaces of side extensions 13 generally follow the surfaces of their respective open-ended slots 24 medially from apertures 20 rearward toward their respective front slot-ends 16. Thus from front slot ends 16, side extensions angle forward away from centerline of open-ended slot 24 proximal to apertures 20. This construction maintains a desired thickness of sides 12 and their side extensions 13. Center extension 22 may have a generally similar thickness longitudinally from proximal to front slot-ends 16 to its forward blunted end, as shown in FIG. 1B. The blunted/rounded forward extent of center extension 22 lies slightly beyond mid apertures 20, as shown in FIG. 1C. The lower extent of center extension 22 may be defined by the lower aspect of frictional surfaces 26 on center extension 22 and associated with open-ended slots 24, as described below. The lower extant of center extension 22 may blend anteriorly with blunt forward end and may, at its rearward end, arch downwardly to merge with center divider 22 proximal to front slot-ends 16, shown in FIG. 1C.

Side extensions 13L and 13R and center extension 22 comprise frictional surfaces 26 on their medial aspects with respect to and facing open-ended slots 24, as shown in FIGS. 1A, 1B, and 1C. Thus, each open-ended slot 24 has at least two frictional surfaces 26, one on each side of the open-ended slot 24 facing each other and extending toward the center of each open-ended slot 24. Side extensions 13L and 13R provide at least one frictional surface 26 on each on their medial surfaces, and center extension 22 comprises at least two frictional surfaces 26, one on each side, left and right. In one embodiment, frictional surfaces 26 further comprise angular ridges forming a generally triangular structure that have a base with a width of about 3 mm and have a height of about 1.5 mm off the medial surfaces of side extensions 13L and 13R and left and right surfaces of center extension 22. Frictional surfaces 26 are generally aligned with the angle of open-ended slots 24 defined above. Frictional surfaces 26 generally form the primary surface in open-ended slots 24 which climbing rope 38 contacts when situated in open-ended slot 24.

A loop of rope 38 retained within slot 10 by snap link 40, as described above and shown in the figures, has two strands exiting the top of slot 10. One strand may be placed within open-ended slot 24 and may be entrapped within open-ended slot 24 by attachment of snap link 44 through apertures 20L and 20R. In this condition, the strand of rope 38 may not be removed through the front end of previously unobstructed open-ended slot 24 without first removing snap link 44 from apertures 20L and 20R. In addition, rope 38 is inhibited from moving through the inventive rope handling devices 100 and 101 when said strand of rope 38 is entrapped as described above.

When viewed from above, as shown in FIG. 1B, side extensions 13L and 13R are seen to angle medially from approximately mid apertures 20L and 20R to their forward most extent, thus narrowing the distance between the forward structure of apertures 20L and 20R. Thus from front slot ends 16, side extensions angle forward away from centerline of open-ended slots 24 and then angle medially toward centerline of open-ended slots 24. This construction is preferred for some embodiments and may better accommodate placement of snap links 44 (and 64, as shown in FIG. 6) through apertures 20L and 20R. In addition, providing a narrower distance between the forward most ends of side extensions 13L and 13R better distributes forces to snap link 64 when rope handling device 100 is attached to a climbing anchor 42 for belay of a follow, as shown in FIG. 6.

Rope handling device 101, having a single slot 10 and no center divider 14 or center extension 22, comprises a single open-ended slot 24 formed between side extensions 13L and 13R. The dimensions of open-ended slot 24 and construction of side extensions 13L and 13R including material thickness, frictional surfaces 26, and apertures 20L and 20R, may correspond to those described above for rope handling device 100. Open-ended slot 24 may incorporate two frictional surfaces 26, one on each side extension 13L and 13R. Apertures 20L and 20R in rope handling device 101 are closer to each other than in rope handling device 100, and thus only minimal medial angling of forward extent of side extensions 13L and 13R is beneficial for attachment of snap link 44 or 64.

For belay of a follow off an anchor 42, rope handling devices 100 and 101 both allow for attachment of a snap link 64 to anchor 42 through apertures 20L and 20R, as illustrated in FIG. 6. Side extensions 13L and 13R are constructed so as to provide adequate strength, critically around apertures 20L and 20R, to accommodate the forces associated with climbing that are generated when a snap link 64 is positioned within apertures 20L and 20R and used as an anchoring device.

### Alternate Constructions

It will be appreciated that rope handling devices of the present invention may be provided using constructions and manufacturing techniques other than as specified above without departing from the scope and spirit of the invention. In some embodiments, for example, rope handling devices may have a similar structure and incorporate similar constituent elements and features without having a unitary construction. Exemplary alternative embodiments of devices of the present invention are described below.

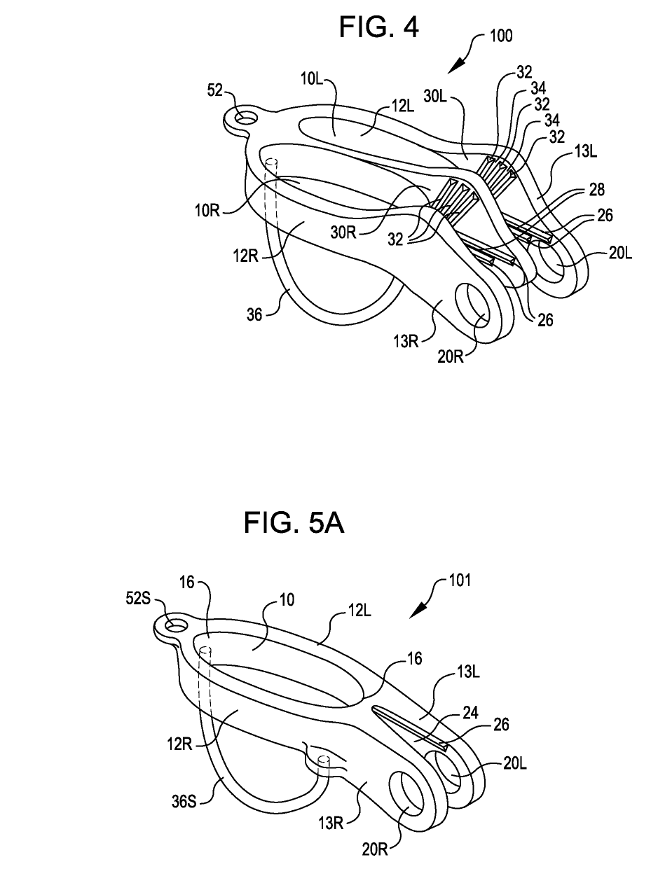

Referring to FIGS. 4, 5B, and 10 rope handling devices 101 and 100 may further comprise rope channels 30, 30L and 30R projecting upward from front slot-ends 16, 16L and 16R. Channels 30, 30L and 30R may additionally comprise ridges 32 and/or grooves 34. Modifications to preferred rope handling device 100 and 101 such as rope channels 30, 30L and 30R, may be added to provide increased friction during braking, lowering and rappelling without departing from the scope of this invention.

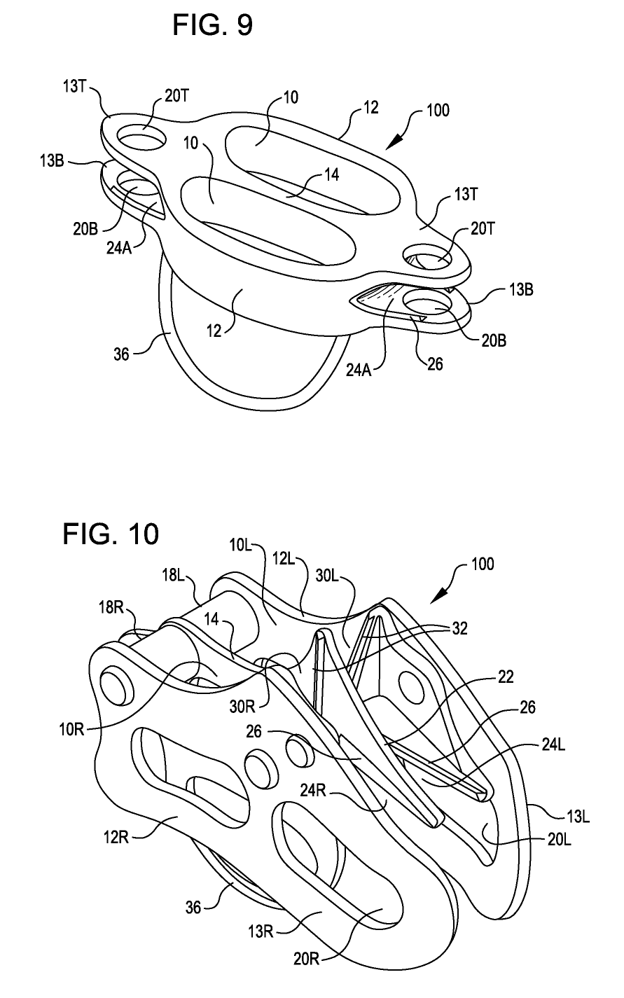

Frictional surfaces 26 of side extensions 13L and 13R and center extension 22 may comprise multiple ridges, parallel or not, with corresponding grooves 28 as shown in FIGS. 4 and 5B. Ridges of frictional surfaces 26 may have a profile other than an angular profile, such as a half round in cross section profile, or another curved or angular profile. Tapered frictional surfaces 26 of side extensions 13L and 13R and frictional surfaces 26 of center extension 22 may alternatively be provided without ridges and may consist of a smooth or textured surface without departing from the scope of the invention. Further, frictional surfaces 26 of open-ended slots 24, may angle such as to terminate below apertures 20L and 20R, or within the height of apertures 20L and 20R, or may be otherwise constructed in proximal relation to apertures 20L and 20R without departing from the scope of the present invention (See, e.g., FIG. 9 alternate embodiment described below).

Open-ended slots 24 may be oriented or angled in orientations other than as illustrated, such as horizontal, or angling upward or further downward. Open-ended slots 24 may have a variety of configurations and sizes other than specified in herein and may incorporate, for example, longitudinal concave or convex arching configurations (appearing “U” shaped or half “hourglass” shaped viewed from above) without departing from the scope of the present invention.

Center extension 22 of rope handling device 100 may vary in thickness from one end to the other, i.e., from the front to rear, for example, such that the narrow aspects of open-ended slots 24 proximal to front slot ends 16 are more centrally located in relation to respective slots 10 without departing from the scope of the present invention Likewise, center divider 14 may comprise a single metal rod or shaft that extends forward to form extension 22, or it may be otherwise formed within the scope of the present invention.

Slots 10 may have a variety of shapes and configurations as viewed from above, such as oval or rectangular or other curved or polygonal configurations, and may have different dimensions from those specified above without departing from the scope of the present invention.

Retainer loop 36 may be constructed other than as described, such as of cast, molded, or formed material provided as an extension of center divider 14, or as an extension of one side 12, while remaining within the scope of the present invention. Retainer loop 36 may connect various elements on the lower surface of an alternative embodiment. The angled orientation of retainer 36S, as shown in FIG. 5, may be reversed from the embodiment illustrated and described above, for example. Additionally, retainer 36S may be provided to pass at an angular orientation below slot 10 as part of a solid body construction, or be otherwise constructed within the scope of the present invention.

Accessory cord opening 52 or 52S as described above may be constructed in a variety of ways, such as punch cut or machined in a center divider made from metal sheet stock, or may be of alternate shape, such as an open-sided hole or hook contained within an alternate stamped or formed retaining loop 36, and remain within the scope of the present invention.

Slot-ends, 16 and 18, sides 12 (and center divider 14, if applicable) may extend equidistant downward, or be otherwise formed than specified above without departing from the scope of the present invention. For example, sides 12L and 12R and slot-ends 16 and 18 may have substantially similar height and thickness, as would result by construction from a bent metal rod using a construction similar as that of a chain link. Further, slot-ends 16 and 18 may not exhibit the above specified angling away from each other on their lower surfaces without departing from the scope of the invention.

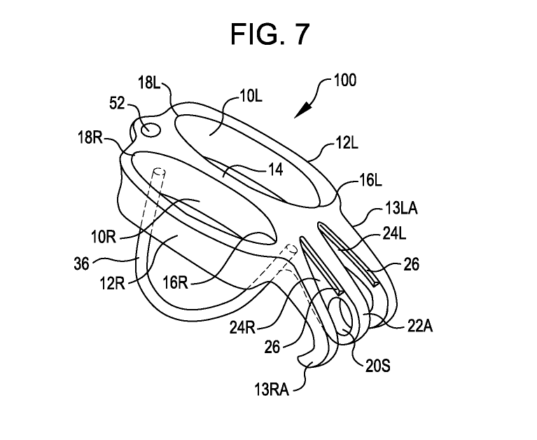

Apertures 20L and 20R may be shaped or positioned otherwise than shown in the figures and described above. As an example, apertures 20L and 20R may be provided as oblong openings within side extensions 13L and 13R (See, e.g., FIG. 10 alternate embodiment described below). In another embodiment, apertures 20L and 20R may extend rearward to or beyond front slot-ends 16 without departing from the scope of the present invention. Alternate embodiments described below for FIGS. 7 and 9 offer other examples of apertures 20 within the scope of the invention.

An alternate rope handling device 100 of the present invention, shown in FIG. 10, may comprise sides formed from flat sheet metal stock machined or punch cut and bent medially at forward ends of side extensions 13L and 13R. Apertures 20L and 20R may be provided as elongated slots having rounded ends in side extensions 13L and 13R. The outer surfaces of side extensions 13L and 13R do not necessarily follow the taper angle of inner surface of open-ended slots 24 in this alternate construction. Frictional rope contact surfaces of open-ended slots 24 may be formed of cast or forged or machined three dimensional parts as shown, or by metal rods or otherwise constructed components assembled to form the device. Center divider 14 and extension 22 may be formed from separate materials, either forged or machined as shown, or otherwise constructed and attached by mechanical means to sides and associated parts. Rear slot-ends 18L and 18R may be formed by sleeves of metal through which a mechanical fastener attaches sides 12L and 12R and center 14 in an alternative rope handling device 100. As described above, open-ended slots 24 may taper from a narrow end at front slot-ends 16L and 16R to a wider area proximal to apertures 20L and 20R at forward aspects of center extension 22 and side extensions 13L and 13R. Entrapment of rope 38 within open-ended slots 24 is accomplished as described above.

An additional alternate rope handling device 100 of the present invention, shown in FIGS. 11A-11C, may comprise sides 12 and side extensions 13, as well as center divider 14 and center extension 22. In this embodiment, two closed-ended slots 10 are provided in a side-by-side relationship formed between sides 12 and center divider 14, and two open-ended slots 24 are formed between center extension 22 and the respective side extensions 13. Center extension 22 has a downwardly angled orientation that generally matches the downwardly oriented configuration of side extensions 13. The surfaces of extensions 13 may be angled or flared away from center extension 22 in the area near and extending downwardly from the front of the closed-ended slots, as shown in FIG. 11. Ridges or other mechanical frictional mechanisms may be provided on surfaces of center extension 22 and/or the sides of extensions 13 to promote retention of ropes within the open-ended slots 24.

As specified above for FIG. 10, apertures 20 may be elongated and side extensions 13 may curve medially to better accommodate a snap link through apertures 20. Apertures 20 formed by extensions 13 illustrated in the embodiment shown in FIGS. 11A-11C are generally large and extend from areas below the closed-ended slots to areas below and in proximity to the open-ended slots. A retainer loop 36 may be provided as curved extension of divider 14, extending generally below the closed-ended slots and behind the open-ended slots. An additional loop or accessory cord opening 52 may also be provided as another curved extension of divider 14, extending generally “behind” the closed-ended slots. The device embodiment illustrated in FIGS. 11A-11C incorporates complex curved shapes for sides 12, side extensions 13 and rear slot ends 18, which may be produced by manipulating flat sheet stock through forging or pressing operations to achieve the desired form of rope handling device 100.

In this embodiment, an integral, generally U-shaped unitary component forms sides 12, including extensions 13 and the rear slot ends 18, and center divider 14 and its extension 22 is formed as a unitary component from a separate piece of material. The curved, integral sides 12 may be mechanically attached to the center divider 14 by means of a fastener F positioned as shown in FIG. 11A. Fastener F is generally positioned forward of front ends of the closed-ended slots and a mechanical interlock is formed between center 14 and rear slot ends 18, which slot ends 18 are contiguous with sides 12. It will thus be appreciated that rope handling devices of the present invention may be constructed from multiple components mechanically fixed together with necessary and aesthetic varying associations without departing from the scope of the present invention.

FIG. 7 shows an alternate rope handling device 100 of the present invention in which a single aperture 20S through an alternate center divider extension 22A is used in place of apertures 20L and 20R in side extensions 13L and 13R as described above. Sides 12L and 12R of the rope handling device 100 illustrated in FIG. 7 have alternate side extensions 13RA and 13LA constructed such that snap link 44 attached through single aperture 20S cannot twist and inadvertently release rope 38 from open-ended slots 24 during rope entrapment. Entrapment of rope 38 is accomplished as described above with the exception that snap link 44 is now attached through single aperture 20A. Following placement of a locking member through aperture 20A open-ended slots 24L and 24R are securely closed to forward passage of strand of rope 38 when said strand is within open-ended slot 24L or 24R.

Another alternative embodiment of the rope handling device 100 of the present invention is shown in FIG. 9. In this embodiment, extensions 13T and 13B project horizontally from top and bottom surfaces of the body of the device, and correspond to side extensions 13L and 13R in the embodiments described previously. Extensions 13T and 13B incorporate apertures 20T and 20B that are generally aligned with one another and provide a generally vertical passageway for receiving a snap link. Extensions 13T and 13B also form open-ended slots 24A. The axial orientation of open-ended slots 24A is generally orthogonal (e.g., rotated about 90 degrees) with respect to the rope receiving axis of slots 10. In other embodiments, the axial orientation of one or more open-ended slot(s) may be arranged at an angle other than orthogonal to a rope receiving axis of the closed-ended slot(s). Open-ended slots 24A (in addition to the ‘open end’ beyond apertures 20T and 20B) present slot openings to the left and right side rather than top and bottom as with open-ended slots 24L and 24R as described above. Frictional surfaces 26 of open-ended slots 24A may incorporate ridges above and below each other, and apertures 20T and 20B are oriented in an above and below relationship. Apertures 20T and 20B are sized and configured and aligned to accept passage and attachment of a second snap link 44 through both apertures 20T and 20B, blocking respective open-ended slots 24A. As described above, a strand of rope 38 retained in slot 10 may be placed in open-ended slot 24A (from either left or right horizontal side of this device embodiment) and entrapped therein by attaching second snap link 44 through both apertures 20T and 20B. Such an alternate inventive rope handling device construction 100 may be symmetrical as shown, with extensions 13T and 13B on either end of slots 10 providing for an open-ended slot 24A and corresponding apertures 20T and 20B at each end. Apertures 20T and 20B may also accommodate accessory climbing cord.

It will be understood in view of the examples above, that geometrical orientations, sizes and configurations other than those specifically described above with respect to various components and elements of rope handling devices 100 and 101, and particularly with respect to closed-ended slot(s), extensions and their respective structures, aperture(s) 20, frictional surfaces 26, and corresponding open-ended slot(s) 24, are within the scope of devices of the present invention.

Functional Description and Operation Belay with Representative Prior Art Slotted Device

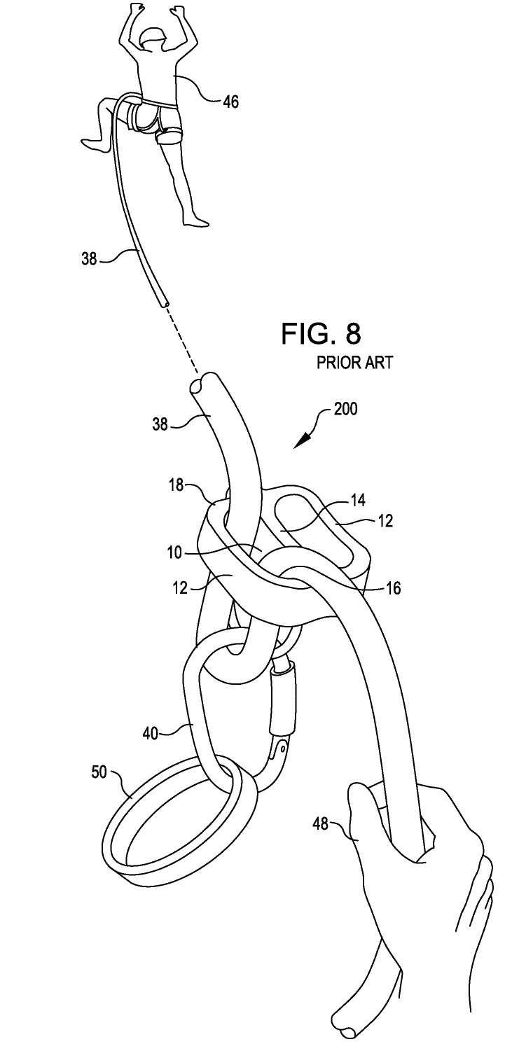

Belay of a lead climber requires skill and coordination that is well understood to those practiced in the art; the following brief description does not constitute instruction. An example of belay of lead climber 46 with a representative prior art symmetrical slotted belay-rappel device 200, as shown schematically in FIG. 8, involves retaining a loop of climbing rope 38 through slot 10 using snap link 40 attached to the loop of rope 38. Snap link 40 is also attachable to belayer's harness loop 50 (belayer is not shown in figures), such that both strands of said loop of rope 38 exit the top of slot 10. The strand of the loop of rope 38 that is attached to climber 46 is termed the “lead end” or “climber's end” of rope 38. The other strand of said loop of rope 38 is held in the belayer's brake hand 48 and is designated the “brake end” of rope 38.

Belay of lead climber 46 with slotted belay device 200 involves movement of rope 38 in both directions by pulling and shuffling actions of the belayer's brake hand 48 on the brake end of rope 38 and other hand (not shown) on the lead end of rope 38 such that the lead end of rope 38 moves with climber 46. During belay of lead climber 46, rope 38 is passed through protection attached to the rock (not shown) and placed by climber 46 between belay device 200 and climber 46. To arrest a fall of climber 46 the belayer's brake hand 48 grips tightly and pulls down sharply on the brake end of rope 38. This action forces rope 38 to run in a convoluted path up and over front slot-end 16 of belay device 200, down through slot 10, around snap link 40, and back up through slot 10 passing against rear slot-end 18, on its path to climber 46. This convoluted rope path in conjunction with grip of brake hand 48 on rope 38 stops travel of rope 38 and holds climber 46 from falling further than rope 38 has stretched and slid through the upper most piece of protection (not shown). This action is termed “arresting” a fall or “catching” the climber 46. Stopped motion of rope 38 by such action is termed “lock off”.

In order to maintain “lock off” with belay device 200, the belayer's brake hand 48 must continue to grip and pull down on the brake end of rope 38 or the belayer must secure the brake strand by “tie off” with special knots or attach an accessory rope locking apparatus (not shown). With the exception of proper securing of the brake strand, brake hand 48 must be wrapped around the brake end of the rope 38 continuously during belay in order to grip rope 38 immediately in the event of climber 46 falling, and thereby “arrest” such a fall or “catch” the climber 46.

It is to be noted that either slot 10 may be utilized for a single rope belay with belay device 200 which is also true for slots 10L and 10R of rope handling device 100 of the present invention. Also, because belay device 200 is symmetrical, the designation of front and rear slot-ends 16 and 18 are here defined by the brake strand of rope 38 and the strand tied to climber 46. Rope handling devices 100 and 101 of the present invention have front and rear orientations defined by forward extensions 13L and 13R and their corresponding structures and open-ended slots 24L and 24R, and the optional accessory cord opening 52 located proximal to rear slot-ends 18. Thus, devices 100 and 101 of the present invention have correspondingly defined left and right structures as specified above.

Further exemplary descriptions of belay and lock off may refer to slots 10, slot-ends 16 and 18, and open-ended slots 24 without referring to their left and right orientations. In addition, belay using top rope anchors will not be discussed specifically (with the exception of the special case of belay of a second or following climber off an anchor). It will be understood that rope handling devices 100 and 101 of the present invention are suitable for use with top rope belay, as are representative prior art belay devices 200.

Belay with the Devices of the Present Invention

With the following distinctions, rope handing devices 100 and 101 of the present invention are arranged similarly to the representative prior art belay device 200 to belay a leader. A loop of climbing rope 38 is retained through slot 10 by snap link 40 (with link 40 being simultaneously attached to belay loop 50 of a belayer's harness) such that both strands of loop of rope 38 exit the top of slot 10, as shown in FIG. 2A. The strand of the loop of rope 38 that exits nearest rear slot-end 18 is attached to climber 46. The “brake end” strand of said loop of rope 38 exits nearest front slot-end 16 and its associated open-ended slot 24 and is gripped in belayer's brake hand 48. Belay of lead climber 46 is performed as described above for belay device 200 by the belayer passing rope 38 back and forth through rope handling device 100 or 101 using brake hand 48 on brake end of rope 38 and belayer's other hand on the lead end of rope 38, such that the lead end of rope 38 follows the climber's motion.

Catching climber 46 (arresting a fall) with rope handling devices 100 and 101 is similar to the use of slotted belay 200 with the following distinctions. Brake hand 48 grips brake end of rope 38 tightly and pulls down sharply forcing brake end of rope 38 to run in a convoluted path up through open-ended slot 24, up and over front slot-end 16, down through slot 10, around snap link 40, and back through slot 10 passing against rear slot-end 18, on its path to climber 46. The frictional surfaces 26 of tapered open-ended slot 24 in contact with the brake strand of rope 38 pinch the sides of brake strand of rope 38 and induce additional friction at the start of the convoluted path of rope 38. This additional friction greatly reduces the force required by brake hand 48 to arrest a fall and “lock off” rope 38. Maintaining “lock off” also requires less grip force of brake hand 48 on rope 38 and is less tiring for the belayer than with a device such as 200. The extra friction on rope 38 provided by frictional surfaces 26 on the interior of open-ended slot 24 during braking and lock off is desirable for a light belayer with a heavy climbing partner, and with the use of skinny modern ropes which produce less friction in rope handling devices than larger ‘standard’ ropes. Also, rope handling devices 100 and 101 provide smooth movement of rope 38 on belay with either larger ‘standard’ or newer skinny single or double ropes by slot dimensions specified above accommodating the larger rope sizes.

### Entrapment of Rope in Open-Ended Slots

Further advantage is obtained with rope handling devices 100 and 101 of the present invention by allowing the belayer to secure the “lock off” easily without having to tie special knots or attach an accessory rope locking device. Secure “lock off” is achieved by pulling brake end of rope 38 further into and below open-ended slot 24, past apertures 20L and 20R and attaching snap link 44 simultaneously through both apertures 20L and 20R, as shown in FIG. 2B. The open-ended slots (or ‘slot’ for rope handling device 101) 24 are effectively closed by the attachment of snap link 44 simultaneously through both apertures 20L and 20R and brake strand of climbing rope 38 is unable to pass out the previously un-obstructed end of open-ended slot 24. Snap link 44 through apertures 20L and 20R blocks the strand of rope 38 from passing out the wide end of open-ended slot 24. This entrapment of brake end of rope 38 within open-ended slot(s) 24 is designed to provide secure “lock off” of rope 38 without brake hand 48 controlling brake end of rope 38 such that rope 38 will not move through rope handling devices 100 or 101 from the weight of climber 46. This secure “lock off” is hereinafter referred to as “secondary lock off” and is understood to refer to entrapment in open-ended slot(s) 24 of the brake strand (or strands, see below for double ropes) of climbing rope(s) 38 retained in slots 10 for belay or rappel as described above and described further below. With “secondary lock off,” the belayer is now free to release brake hand 48 off rope 38 to rest or use hands for some other task.

To lower climber 46 attached to rope 38, the rope must move through rope handling device 100 or 101 in a controlled fashion. Following a “secondary lock off,” the belayer re-grips rope 38 tightly with belay hand 48 and applies grip force necessary to hold rope 38 in open-ended slot 24 as snap link 44 is removed from apertures 20L and 20R without allowing slippage of rope 38 through rope handling device 100 or 101. Open-ended slot 24 is no longer blocked. Climber 46 is now again “locked off”. Belayer then moves brake hand 48 forward in an arced motion and carefully relaxes grip on rope 38 simultaneously. This action moves rope 38 into a wider area of open-ended slot 24 and decreases the friction on rope 38 between frictional surfaces 26 of interior of open-ended slot 24. This position of rope 38 also alters the convoluted rope path, and in conjunction with less grip force applied to rope 38 by brake hand 48, rope 38 will slide through rope handling device 100 or 101 in a controlled fashion, thereby lowering climber 46. During lowering, the brake end of rope 38 may be in front of open-ended slot 24 or may slide within and against the frictional surfaces 26 of open-ended slot 24 if greater control of movement of rope 38 is desired. Thus, in addition to providing “secondary lock off”, open-ended slots 24 also facilitate control of lowering, braking, and arresting a fall, with both large and small diameter climbing rope sizes that are currently being used by climbers.

“Secondary Lock Off” with Two Ropes

In addition to the above description and referring to FIG. 3B, “secondary lock off” will be understood to apply to rope handling device 100 whereby two climbing ropes 38 each have a loop retained in an individual slot 10L or 10R by a single snap link 40, and the brake ends of the two ropes 38 are entrapped simultaneously within individual open-ended slots 24 by attachment of a single second snap link 44 through apertures 20L and 20R. It is intended that such “secondary lock off” should occur with the brake end of each rope 38 entrapped in the open-ended slot 24 associated with the slot 10 in which that particular rope 38 is retained by snap link 40. However, “secondary lock off” may also occur with the two brake ends crossing each other, resulting in their entrapment within the open-ended slot 24 associated with the other slot 10, right to left or left to right. Further, it is to be noted that “secondary lock off” with rope handling device 100, having a single rope 38 retained in a slot 10 by snap link 44, may occur with the brake end entrapped within the open-ended slot 24 associated with the other slot 10 that is not retaining the loop of rope 38. In addition, “secondary lock off” may be performed without tension on the climber's strand(s) (or anchor strand(s) described for rappelling, below).

In “secondary lock off” without tension on the climber's or anchor strand, rope 38 cannot pass further through devices 100 or 101. This function may be used advantageously for safe movement of a rappelling climber prior to rappel and safe preparation for belay of a lead climber on multi-pitch climbs. Prior to rappel, “secondary lock off” allows the rappelling climber to have the rope configured in devices of the present invention and set up for rappel, but have it securely locked off. The rappelling climber can remove other safety attachments and remain secure and safe without having a hand on the brake rope. While preparing to belay a climber high on a multi-pitch climb, the belayer can securely lock off the inventive rope handling device with a predetermined distance of rope to the tied in climber, who can then safely remove other safety attachments prior to starting to climb. The climbers may also re-position themselves safely without the belayer having to maintain a grip on the brake strand.

### Double Rope Belay

A lead climber 46 may climb and be belayed attached to two ropes 38, also known as double ropes, as shown in FIG. 3A. A loop from each rope 38 is retained in rope handling device 100 through its separate slot 10L or 10R by snap link 40, which is simultaneously attached to belay loop 50. The “lead ends” of loops of double ropes 38 (attached to climber 46) both exit slots 10 nearest their respective rear slot-ends 18L and 18R. “Brake ends” of double ropes 38 exit slots 10 nearest their respective front slot-ends 16L and 16R. Belay, “catching” the climber 46 (or “arresting” a fall), and lowering are all similar to that described for belay with single rope with the exception that the belayer must maintain a grip on “brake ends” of both ropes 38 simultaneously in brake hand 46.

“Secondary lock off” for belay of climber 46 using two ropes 38 with rope handling device 100, shown in FIG. 3B, is achieved by brake hand 48 guiding brake ends of both ropes 38 into open-ended slots 24L and 24R. Brake hand 48 then pulls brake ends of double ropes 38 below open-ended slots 24L and 24R, past apertures 20L and 20R, and snap link 44 is attached through both apertures 20L and 20R simultaneously to entrap both brake strands of rope 38 and achieve “secondary lock off” with double ropes.

### Rappel

Rappel on double strands of climbing rope 38 is well understood to those familiar with the art. Rope handling device 100 is configured for rappel with two strands of rope 38 similar as for belay with two ropes 38 described above, FIG. 3A, but the end of the two ropes 38 that were attached to lead climber 46 now pass to a rappel anchor (not shown) and are connected to each other or are two sides of the same rope 38, and harness loop 50 is on the harness of the climber (not shown) who is to rappel—there is no belayer. Brake hand 46 is associated with the rappelling climber who is wearing the harness with loop 50 attached. The climber to rappel thus controls lowering, and “lock off” with her/his brake hand 46. On rappel the inventive “secondary lock off” of rope handling device 100 is achieved as described above for “secondary lock off” for belay with double ropes 38 and allows the climber who is rappelling to hang on rappel and have full use of both hands with a safe, secure, and simple means.

Rappel on a single rope is understood by those familiar with the art. Configuration of rope handling devices 100 or 101 at the location of the climber who is to rappel is similar to the single rope belay described above. For purposes of this description, assume a fixed line—rope 38 attached securely to an anchor above instead of the climber 46 in FIG. 2B. As described above for double rope rappel, brake hand 46 is associated with the rappelling climber who is wearing the harness with loop 50 attached and said climber controls lowering and lock off. “Secondary lock off” on single rope rappel is achieved as described above for a single rope belay.

### Rope Channels

Rope handling devices 100 and 101 of the present invention may employ channels 30 in addition to open-ended slots 24 to increase control of rope 38 while braking, lowering, and rappelling with single or double ropes. With rope handling devices 100 or 101 of the present invention, configured with channels 30, braking, lowering and rappelling as described above involve brake end of rope 38 passing through channel 30 and may or may not involve brake end of rope 38 within open-ended slot 24 to provide additional friction to that provided by channel 30. The “secondary lock off” remains unchanged; brake end of rope 38 pulled into open-ended slot 24 past apertures 20L and 20R and snap link 44 attached through both apertures 20L and 20R simultaneously entraps rope 38 within open-ended slot 24.

### Reverse Rope Configuration for Belay-Rappel

The following description is not illustrated in figures. Rope handling devices 100 and 101 of the present invention may be used for belay and rappel in a reversed rope configuration if less friction is desired and/or the option of “secondary lock off” is undesirable. In this reversed rope configuration, a loop of climbing rope 38 is retained through slot 10 by snap link 40 as described above with link 40 simultaneously attached to belay loop 50. Both strands of loop of rope 38 exit the top of slot 10. The strand of rope 38 that exits nearest front slot-end 16 and its associated open-ended slot 24 is attached to climber 46 in this reversed configuration. The “brake end” strand of loop of rope 38 exits nearest rear slot-end 18 and is gripped in brake hand 48. Belay of lead climber 46 is performed as described above for representative prior art belay device 200 including catching a fall, lowering, and “lock off”. The convoluted path of rope 38 passes over rear slot-end 18 in this reversed rope configuration without passing through or running over an open-ended slot 24 or rope channel 30 and thus the rope 38 behaves similarly as when in belay device 200. “Secondary lock off” may or may not be possible in this reversed configuration because the lead strand of rope 38 attached to climber 46 (or anchor strand attached to anchor for rappel) may interfere with positioning of the brake end of rope 38 in open-ended slot 24 on the opposite side of rope handling device embodiments 100 or 101, or the brake strands' rope path is so altered that secure “secondary lock off” is not possible. The above conditions and restrictions with reversed rope configuration apply to use of rope handling device 100 with double ropes.

### Belay of Follow Off Anchor

Belay of a follow (or belay of the second) off a climbing anchor is well understood to those familiar with the art. Belay of a follow with rope handling device 101 is not shown but corresponds to single rope belay of a follow with rope handling device 100 described below. To belay a following climber 66 off anchor 42 with rope handling device 100 a snap link 64 is attached to anchor 42 and to rope handling device 100 through both apertures 20L and 20R such that the device hangs with its rear slot-ends 18 down and its forward slot-ends 16 up closer to the anchor, as shown in FIG. 6. A loop of rope 38 is retained through slot 10 by snap link 70 such that both strands of loop of rope 38 exit slot 10 on its upper surface (referring to embodiment's original defined orientation) which now faces out from the rock wall (not shown). Snap link 70 is attached through retainer loop 36 (or 36S for rope handling device 101) and through the loop of rope 38 passing through slot 10. Snap link 70 is not attached to the belayer's harness loop 50 as with previously described snap link 40 with belay of a leader. The strand of rope 38 exiting slot 10 nearest front slot-end 16 is attached to the follow, or second climber 66. The “brake end” of rope 38 exits slot 10 nearest rear slot-end 18 and is held by the belayer's brake hand 48 with the belayer secured at the anchor (not shown). This brake strand of rope 38 is below the following climber's strand of rope 38 in the now substantially vertically oriented slot 10.

During belay when the “follow” climbs, the belayer pulls downward on the brake end of rope 38 and coils or otherwise manages the accumulating rope. In the event seconding climber 66 falls, the strand of rope 38 attached to seconding climber 66 pulls down on top of the brake strand of rope and presses the brake strand firmly against rear slot-end 18 producing friction adequate to “arrest” the fall without the belayer having to grip the brake strand forcefully. This pressure of the climber's strand on the brake strand results in “lock off” (autoblock) of rope 38. Once rope 38 is “locked off” after such a fall the belayer can release all force from brake hand 48 on the brake end of rope 38 and the climber will remain “locked off” as long as there is tension on the climber's strand of rope 38. This autoblock locking of the rope to the following climber when belayed off the anchor greatly reduces the effort required of the belayer to arrest a fall and requires no effort to hold a hanging climber. If the “follow” must hang on rope 38 in order to rest the belayer pulls as much rope as possible on the brake strand and advises the “follow” sit into their harness or step downwards. The downward tension on the climber's strand causes rope 38 to “lock off” by the pressure exerted on the brake strand. As with belay of a leader described above, the belayer of a following climber should always maintain a hand on the brake end of the rope as long as the climber is not securely “locked off” with the rope “tied off” or with attachment of an accessory rope locking device.

As with belay of a lead climber, the following climber may be belayed with two ropes (not shown). For such belay the two ropes are each retained in a separate individual slot 10L and 10R of rope handling device 100 with a single snap link 70 as described above for a single rope 38. Rope handling device 100 is attached to anchor 42 as described above with snap link 64. The following climber is “tied in” to the strands of each rope that exit slots 10L and 10R closest to front slot-ends 16L and 16R as described above for a single rope. The belayer must hold onto both ropes' brake strands that exit slots 10L and 10R nearest rear slot-ends 18L and 18R. Belay and lock off are accomplished as described above for single rope with the belayer managing the accumulation of two ropes and maintaining a grip on both brake strands unless they are securely locked off.

### Belay of Two Follows Off Anchor

Belay of two follows off an anchor is possible with rope handling device 100 using two ropes. Rope handling device 100 and two ropes are configured similarly at anchor 42 to that described above for use of double ropes and a single following climber with the exception that each rope is now tied to a separate climber. As described above for a single following climber the strand tied to each of two following climbers exits its slot 10 nearest front slot-end 16. Significantly, each second climber's rope will lock independently in the event of a climber's fall. In the instance of one seconding climber hanging on their rope in a locked off condition, the preferred embodiment allows easy motion of the unlocked climber's rope because of the dimensions of sides 12, center divider 14, and slot-ends 16 and 18 specified above. The dimensions are such that rope 38 has freedom of motion and is not pinched between retaining snap link 70 and slot-ends 16 and 18 when snap link 70 is pulled against lower surfaces of sides 12 and center divider 14 as during a fall or resting of one following climber described above.

Release of Lock Off with Belay Off Anchor

Release of “lock off” while belaying off an anchor is usually achieved by the “follow” climbing upward and reducing tension on the climber's strand of rope 38. If this is not possible, or if the seconding climber needs to be lowered because the climbing is too difficult, a special procedure must be followed. An accessory cord may be attached to opening 52 on rope handling devices 100 and 101. This cord is elevated by techniques familiar to those skilled in the art such that rope handling device 100 or 101 moves to a substantially inverted position from its substantially vertical position during belay off the anchor 42. Such a change in orientation of embodiments 100 or 101 results in the climber's strand of rope 38 moving away from the brake strand of rope 38, thereby releasing pressure on the brake strand between climbing strand and rear slot-end 18 thus reducing friction on the brake strand and allowing the following climber to be lowered. As with all belay activities described herein the belayer must maintain a grip on the brake end of rope 38 when the rope is not securely “locked off”, in this instance to control lowering.

### Initiating Escape of Belay

Escape from the belay with a rope handling device configured as described above for belay of a lead climber is occasionally required if a climber is injured and cannot be lowered safely by the belayer who must then seek assistance. It requires skills that are understood to those practiced in the art. Escape from the belay first requires that the belayer securely “lock off” the rope to the fallen climber. Typically, several special knots are used to provide this secure lock off, which is termed “tying off” the belay. Tying these knots usually results in some undesirable rope slippage. Rope handling devices 100 and 101 of the present invention eliminate the need for tying these special knots by allowing the belayer to perform the inventive “secondary lock off” described above without any significant rope slippage. This “secondary lock off” is simple and safe, and can easily be done at a time when the belayer may be agitated from the events that have transpired to incapacitate the climber. This can give the belayer time to compose himself or herself and plan a course of action. Other procedures required to anchor the secure lock off (“secondary lock off” with reference to rope handling devices 100 and 101) and complete an escape of the belay require that the belayer has the requisite knowledge and equipment and will not be described here.

Thus it is shown that rope handling devices 100 and 101 of the present invention combine many favorable features and provide the capability to securely lock off the movement of climbing rope through a rope handling device with only the attachment of a second snap link to entrap the brake strand within an open-ended slot, herein termed “secondary lock off”, for use on belay or rappel, with or without tension on the rope, and for use with one or two ropes.

### REFERENCE NUMERALS USED IN FIGS

100 double slot rope handling device
101 single slot rope handling device
200 prior art symmetrical double slot belay device
10 slot
10L left slot
10R right slot
12 side
12L left side
12R right side
13L left side extension
13R right side extension
13T top alternate extension
13B bottom alternate extension
13LA alternate embodiment left side extension
13RA alternate embodiment right side extension
14 center divider
16 front slot-end
16L left front slot-end
16R right front slot-end
18 rear slot-end
18L left rear slot-end
18R right rear slot-end
20L left extension aperture
20R right extension aperture
20T top alternate extension aperture
20B bottom alternate extension aperture
20S single aperture in alternate center extension
22 center extension
22A alternate embodiment center extension with snap link aperture
24 open-ended slot
24L left open-ended slot
24R right open-ended slot
24A alternate open-ended slot
26 frictional surface in open-ended slot
28 groove in open-ended slot
30 channel for additional rope friction
   30L left channel
30R right channel
32 ridge in channel
34 groove in channel
36 retainer loop
36S retainer loop single slot device
38 climbing rope
40 snap link attached to harness loop and climbing rope through embodiment
42 anchor
44 snap link through apertures for rope entrapment
46 climber
48 brake hand
50 harness loop
52 accessory cord opening
52S accessory cord opening on single slot embodiment
60 longitudinal mid slot reference line
64 snap link attached to anchor and through apertures on embodiment
66 following climber, “the second”
70 snap link retaining rope within embodiment during belay off anchor

1. A rope handling device comprising:
a body forming at least one closed-ended slot with openings to both an upper area and a lower area, the closed-ended slot being sized and configured to receive a loop of rope with the loop positioned through the opening to the lower area and retained in the lower area by positioning of a locking member, and two rope strands exiting the opening at the upper area;
at least one open-ended slot sized and configured to receive a strand of rope, the open-ended slot being positioned beyond a terminus of the closed-ended slot; and
at least one aperture in proximity to an open end of the open-ended slot for attaching a locking member, whereby a strand of rope received through the at least one open-ended slot is entrapped upon positioning a locking member through the at least one aperture.

2. The device of claim 1, wherein the body forms two closed-ended slots separated by a divider and arranged in side-by-side relationship.

3. The device of claim 1, wherein the body forms two closed-ended slots arranged in side-by-side relationship and the device additionally comprises two open-ended slots, with one open-ended slot positioned beyond a terminus of each of the closed-ended slots.

4. The device of claim 1, wherein the at least one open-ended slot is formed between side extensions extending from sides of the at least one closed-ended slot.

5. The device of claim 4, wherein the side extensions are angled to extend away from, and then toward a centerline of the open-ended slot in a direction distal to the closed-ended slot.

6. The device of claim 4, where an aperture is provided in each side extension and positioned distally of the at least one closed-ended slot.

7. The device of claim 1, wherein the at least one open-ended slot has a tapered configuration with a narrower region nearest the closed-ended slot and a wider region at the open end of the open-ended slot.

8. The device of claim 1, wherein two apertures are provided in proximity to the open end of the open-ended slot for attaching a locking member.

9. The device of claim 1, additionally comprising a retainer loop mounted to and forming an arc below the body.

10. The device of claim 1, constructed as a unitary, single piece body.

11. The device of claim 1, constructed from multiple components mounted and fixed together.

12. The device of claim 1, wherein the at least one open-ended slot has at least one frictional surface.

13. The device of claim 12, where the at least one frictional surface is formed by at least one angular ridge.

14. The device of claim 1, wherein an axial orientation of the at least one open-ended slot is substantially similar to a rope receiving axis of the at least one closed-ended slot.

15. The device of claim 1, wherein an axial orientation of the at least one open-ended slot is oriented at an angle to a rope receiving axis of at least one closed-ended slot.

16. In a rope handling device having at least one closed-ended slot open to an upper area and a lower area for receiving a loop of rope such that the loop may be passed through the closed-ended slot from the upper area and extend from the lower area with two rope strands exiting the upper area, the improvement comprising: providing at least one open-ended slot positioned proximal the closed-ended slot for receiving one rope strand and providing at least one aperture positioned proximal the open-ended slot for receiving a locking member, whereby the strand received through the open-ended slot is securely locked in place upon positioning of the locking member through the at least one aperture.

17. A rope handling device comprising: a body having two sides and a center divider forming two closed-ended slots separated by the divider and arranged in a side-by-side relationship, each of the closed-ended slots having an opening to both an upper area and a lower area, and each of the closed-ended slots being sized and configured to receive a loop of rope with the loop positioned through the opening to the lower area, with two rope strands exiting the opening at the upper area; at least one open-ended slot positioned beyond a terminus of each of the closed-ended slots, the open-ended slots being formed between an extension of the divider and the sides; and at least one aperture provided in proximity to each open end of each open-ended slot.

18. A rope handling device of claim 17, wherein the body is constructed from two independent components, a first generally U-shaped component being formed as curved side and side extension elements forming outer walls of the closed and open-ended slots and forming the apertures, and a second component being provided as the divider forming the internal walls of the closed and open-ended slots.

19. A rope handling device of claim 17, wherein the apertures extend from areas below the closed-ended slots to areas below and in proximity to the open-ended slots.

20. A rope handling device of claim 17, wherein mechanical frictional mechanisms are provided on surfaces of the divider extension and/or on the sides forming the open-ended slots to promote retention of ropes within the open-ended slots.
